(19) United States
(12) Patent Application Publication
(10) Pub. No.: US 2008/0152775 A1
(43) Pub. Date: Jun. 26, 2008

(54) INACTIVATION OF FOOD SPOILAGE AND PATHOGENIC MICROORGANISMS BY DYNAMIC HIGH PRESSURE

(75) Inventors: Paul Paquin, Quebec (CA); Jocelyne Giasson, Quebec (CA); Jean-Francois Vachon, Quebec City (CA); Ismail Fliss, Quebec City (CA)

Correspondence Address: OBLON, SPIVAK, MCCLELLAND MAIER & NEUSTADT, P.C., 1940 DUKE STREET, ALEXANDRIA, VA, 22314, US

(73) Assignee: UNIVERSITE LAVAL, Quebec (CA)

(21) Appl. No.: 11/746,431

(22) Filed: May 9, 2007

Related U.S. Application Data
(63) Continuation of application No. 09/926,622, filed on Feb. 20, 2002, now abandoned.
(60) Provisional application No. 60/136,780, filed on May 28, 1999.

(51) Int. Cl. A23C 3/02

(52) U.S. Cl. 426/584; 426/580; 426/587; 426/586

(57) ABSTRACT

The present invention relates to a process using dynamic high-pressure for inactivation of food pathogens. Liquid food are treated by dynamic-high-pressure at 1 to 5 kbars with at least one recirculation depending on the needs. The pasteurization process is performed at relatively cold temperature ranging from 4° C. to 55° C.

### BACKGROUND OF THE INVENTION

(a) Field of the Invention

The invention relates to a process for inactivation of contaminating liquid food pathogens, and more particularly to such a process which utilize a dynamic high-pressure treatment.

(b) Description of Prior Art

Every year, outbreaks of illnesses caused by pathogenic bacteria contaminating foods have economic repercussions throughout the world. Due to its composition and mode of production, milk is particularly susceptible to contamination by a wide variety of bacteria. When milk is secreted in the udders of ruminants, it is virtually sterile. Many milk-borne bacteria are casual visitors but find them in an environment where they can live and possibly proliferate. Although some of these bacteria die when competing with species which find the environment more congenial pathogenic bacteria, such as Listeria, Escherichia, Salmonella, can survive and create dangers for the consumer.

Heat, for instance pasteurization is still the most commonly used technology to inactivate food spoilage and pathogenic bacteria in raw milk and other liquid foods. Although effective, some bacteria may resist thermal treatment, especially Bacillus and Clostridium. Furthermore, high temperatures may induce undesirable losses of flavor as well as denaturation of certain vitamins and nutritive proteins. Reduction in soluble calcium, formations of complexes between constituents, and reduction of cheese yield have also been observed. For example, thermal decomposition of milk β-lactoglobulin produces volatile sulfur compounds that may inhibit fermentation, thus affecting the appearance, taste and nutritional value of milk as well as processing characteristics.

In recent years, many alternative methods have been investigated as means of inactivating food spoilage and pathogenic bacteria. Bactofugation and microfiltration have been proposed and shown to reduce the initial microbial load. These processes still required a heat treatment in order to achieve satisfactory results. The advantages of these methods are better microbial quality and longer shelf life. More recently, high hydrostatic pressure (HHP) technology has been proposed as a new strategy to inactivate both the spoilage and pathogenic bacteria. Using this technology, high pressure (5 to 15 kbars or 500 to 1500 MPascal (MPa)) are often needed to achieve the inactivation effect. Such pressures may affect systems determining morphology, biochemical reactions, genetic mechanisms, membrane, and cell wall structure of microorganisms. Sensivity to high pressure varies greatly from one bacterial specy to another. A pressure of 300 MPa (3000 bars) for 10 to 30 minutes is needed for the inactivation of Gram positive bacteria, yeasts and mildew. Bacillus subtilis spores are inactivated at 1750 MPa. A pressure of 400 MPa for 20 minutes is required to completely inactivate E. coli or bring about an 8-log reduction of Saccharomyces cerevisiae. Unfortunately, the principle of this technology is applied as a batch treatment, that is suitable for small volumes, and the establishment of this method on an industrial scale is difficult and costly.

It is well known that ultraviolet light in the proper dose kills most bacteria, algae, viruses, mold spores, and other microorganisms found in liquids such as water. There have been many ultraviolet water sterilization systems proposed to take advantage of this phenomenon. U.S. Pat. Nos. 4,769,131 and 4,968,437 issued to Noll et al. disclose an ultraviolet purification system in which water is pumped through tubes helically coiled around an ultraviolet lamp to provide maximum ultraviolet exposure time for a given tube length to create a relatively compact sterilization system for potable water.

This system as well as other known systems suffers from a number of drawbacks which make them less than ideal solutions to the water purification problem. Ultraviolet sterilization is not applicable on milk because of the opalescence.

On problem common to these systems is that the liquid must be pumped under pressure past the ultraviolet lamp both before and after filtration. This requires a relatively large pump that draws a relatively great amount of power. In addition, such systems are typically designed to treat tap water, and are incapable of taking water from another source such as collecting water dripping off a condensing coil of a dehumidification or air conditioning system.

In the sterilization of milk, it is necessary to raise the temperature of the milk sufficiently to destroy all bacteria and inactivate enzymes. The rate of destruction or inactivation of these organisms varies with both temperature and the time during which the product is held at an elevated temperature. A method of sterilizing milk and dairy products has been to utilize steam infusion to subject the milk to ultra high temperatures for very short periods of time followed by flash cooling. This has been proven to achieve superior product flavor. Various approaches have been used in the past to accomplish this. For example U.S. Pat. No. 3,156,176 to Wakeman describes a heating apparatus in which steam is supplied into a chamber with the liquid product being introduced in the form of a curtain-like film to expose the fluent product to the elevated steam temperatures. Similarly, U.S. Pat. No. 2,899,320 to Davies and U.S. Pat. No. 3,032,423 to Evans, both utilize apparatus for containing steam in which the product is passed over plates within the steam chamber and heated while the product flows downwardly to a collection point for delivery to a flash chamber. A variation of this method is also described in U.S. Pat. No. 3,771,434 to Davies in which screen panels are used to form a thin film of product for exposure to steam. One major disadvantage of the methods and apparatus described in the foregoing patents is the fact that liquid food products, particularly milk products, have a tendency to burn and collect on heated surfaces which are at temperatures greater than or equal to the temperature of the product itself. Such burning, in addition to fouling the apparatus itself necessitating periodic cleaning, also results in undesirable flavor changes to the milk product.

In an obvious effort to avoid such burn-on and fouling, U.S. Pat. No. 4,310,476 to Nahra and U.S. Pat. No. 4,375,185 to Mencacci attempt to form free falling thin films of milk within a steam atmosphere for raising the product temperature. A problem associated with attempting to form a free falling thin film is that the integrity of such films is very unstable and are subject to splashing or break-up in the presence of moving or circulating steam and gases. Film formation requires close adherence to flow parameters and such devices are also subject to the product burn-on problems when hot surfaces are contacted. Additionally, it is recognized as discussed in the Nahra patent that physical agitation of milk may also affect the ultimate flavor of the treated product and disturbance of the free falling films will result in such agitation.

U.S. Pat. No. 6,019,947 discloses a method and apparatus for sterilization of a continuous flow of liquid, which utilize hydrodynamic cavitation. This apparatus uses relatively low pressure (200 to 500 PSI), and the only one cellular lytic mechanism is cavitation. The maximum sterilization yield allows reduction in bacterial counts of only 4 logs.

Another problem associated with many of the prior art approaches to steam infusion of liquid products is that the devices are not easily cleaned for example with the use of clean-in-place systems. The more internal components in which the product may collect or burn-on, the more difficult the cleaning process.

It would be highly desirable to be provided with a new process allowing pasteurization of liquid food products without affecting the nutritive value, and preserving all other characteristics of the liquid, like flavor.

### SUMMARY OF THE INVENTION

One aim of the present invention is to provide a process for continuously reducing presence of microorganisms in liquid food product without denaturation consisting of: a) pressurizing a liquid food product; b) passing a liquid food product to be treated through a continuous pressurizing circulating system at a non-denaturing temperature comprising a dynamic high pressure homogenizer; and c) collecting the liquid food product containing a reduced presence of microbes.

Another aim of the present invention is to provide a process wherein the pressure used is between 50 MPa to 500 MPa.

In accordance with the present invention there is provided also a process that needs at least one passage of the liquid food product through the dynamic high-pressure homogenizer.

Another aim of the present invention is to provide a process wherein the microorganisms to be killed may be selected from bacteria, fungi, mould, bacteriophage, protozoan, and virus.

The process may be performed using a milk homogenizer at temperature between 4° C. to 55° C.

Also, one aim of the invention is to provide a process of sterilizing several liquid food products as of milk, juice, liquid food fat, oil, and water.

### BRIEF DESCRIPTION OF THE DRAWINGS

FIG. 1 illustrates the inactivation of three major food pathogens in phosphate buffer by DHP as a function of applied pressure (100, 200 and 300 MPa) and the number of passes (1, 3 and 5).

FIG. 2 illustrates the inactivation of Listeria monocytogeneses (▪), Salmonella enteritidis (▪), Escherichia coil (□) in phosphate buffer by DHP (200 MPa/1 pass) after a mild heat treatment for 10 minutes at 4, 25, 45 or 55° C.

FIG. 3 illustrates the inactivation of Listeria monocytogeneses (▪), Salmonella enteritidis (▪) and Escherichia coil (□) in phosphate buffer by DHP (200 MPa/1 pass) as a function of initial bacterial load (10⁴ to 10⁹).

FIG. 4 illustrates the inactivation of two major food pathogens in raw milk by DHP as a function of applied pressure (100, 200 and 300 MPa) and number of passes (1, 3 and 5).

FIG. 5 illustrates the inactivation of two major food pathogens in raw milk by DHP (200 MPa/1 pass) in response to a mild heat treatment of 10 minutes (25, 45, 55 and 60° C.).

FIG. 6 illustrates the inactivation of two major food pathogens in raw milk by DHP (200 MPa/1 pass) as a function of initial load (10⁵ to 10⁸).

FIG. 7 illustrates the inactivation of Listeria innocua (10⁷ CFU/ml) in raw milk by DHP (200 MPa) at a laboratory (Emulsiflex-C5) or industrial scale (Emilsiflex-C160).

### DETAILED DESCRIPTION OF THE INVENTION

The use of dynamic high-pressure to inactivate food pathogens has never been reported. In contrast to hydrostatic high-pressure treatment (HHP), the dynamic high pressure (DHP) uses low pressure, as about 2 kbars to achieve same bacteria inactivation results. At this relatively low pressure, food constituents are better preserved from mechanical and biophysical damages well characterized in other sterilization approaches.

In accordance with the present invention, there is provided an new alternative to liquid food pasteurization, that is to say dynamic high pressure (DHP). In the milk industry, light pressure homogenization is used to reduce the diameter of fat globules in order to prevent creaming. Pressure is applied to a liquid forced through an adjustable valve causing increased flow speed and a pressure loss, bringing about cavitation, chisel effect, turbulence and collision on the stationary surface, which combine to reduce the size of fat globules.

In a preferred embodiment of the invention, microorganisms are disrupted by a multiplicity of mechanisms during submitting to DHP: the sudden pressure drop, shear stresses, cavitation and impingement. The overall pressure drop and the rate at which it occurs can is responsible for the cell disruption.

It will be apparent to those skilled in the field that the method and apparatus thus described is extremely simple, avoids the problem of product burn-on.

In a particular embodiment of the invention, there is provided with a process to treated liquid food products contaminated, or potentially contaminated with, but not limitatively, Gram positive or Gram negative bacteria, yeast, viruses, protozoan, and mould.

In one embodiment of the invention is to preformed sterilization to pressure up to 40 000 psi.

In accordance with another embodiment of the invention, the DHP can be applied in inactivating bacteriophages in different liquid food products, or also to inactivate enteric viruses such as Hepatitis A, rotavirus, and Norwalk virus contained in water.

It is recognized from the present invention that several food products lend themselves to preservation by the use of DHP to sterilize the products. DHP sterilization destroys microorganisms and inactivates most enzymes that cause product spoilage.

One embodiment of the invention as extending normal shelf life of fresh food while at same time maintaining nutritional quality and ensuring safety, as for example milk, and cheese.

Also, the invention relates to a process for eliminating lactic acid bacteria bacteriophages from cheese plant by treating milk and whey samples.

An another embodiment of the invention is that DHP sterilization of certain food products may eliminate the need for refrigeration. This is particularly true in the case of dairy products such as milk or ice cream mix, to which this invention is primarily directed, although it may be equally applied to other liquid products such as juices.

While the invention has thus been described in relation to a process for treating milk, others skilled in the art will appreciate that other food products in liquid form may also be sterilized as well such as flavored milk, half and half, dairy creams, whipping creams, condensed milk, ice cream milk, shake mix, puddings, custard, fruit juices, etc. Adjustments to the operating pressure and flow rates may be necessary but these variations will be recognized and easily addressed by those skilled in the field.

### EXAMPLE 1

### Inactivation of Some Food Pathogens Using Dynamic High Pressure

Every year, outbreaks of illnesses caused by pathogenic bacteria contaminating foods have economic repercussions throughout the world. Due to its composition and mode of production, milk is particularly susceptible to contamination by a wide variety of bacteria. When milk is secreted in the udders of ruminents, it is virtually sterile. Many milk-borne bacteria are casual visitors but find themselves in an environment where they can live and possibly proliferate. Although some of these bacteria die when competing with species which find the environment more congenial pathogenic bacteria such as Listeria, Escherichia, Salmonella, etc, can survive in milk and create dangers for the consumer.

Heat (e.g. pasteurisation) for instance pasteurisation is still the most commonly used technology to inactivate food spoilage and pathogenic bacteria in raw milk. Although effective, some bacteria may resist thermal treatment, especially Bacillus and Clostridium. Furthermore, high temperatures may induce undesirable losses of flavours as well as denaturation of certain vitamins and proteins. Reduction in soluble calcium, formation of complexes between β-lactoglobulin and κ-casein and reduction of cottage cheese yield have also been reported. Thermal decomposition of β-lactoglobulin produces volatile sulfur compounds (Desmazeaud, 1990) which may inhibit lactic fermentation, thus affecting the appearance, taste and nutritional value of milk as well as its processing characteristics.

In recent years, many alternative methods have been investigated as means of inactivating food spoilage and pathogenic bacteria. Bactofugation and microfiltration shows to reduce the initial microbial load. These processes still required a heat treatment in order to achieve satisfactory results. The advantages of these methods were better microbial quality and longer shelf life. Recently, high hydrostatic pressure (HHP) technology has been proposed as a new strategy to inactivate both the spoilage and pathogenic bacteria. Using this technology, high pressures (1 to 15 kbars or 100 to 1 500 MPa) are often needed to achieve the inactivation effect. Such pressures may affect systems determining morphology, biochemical reactions, genetic mechanisms, membrane and cell wall structure of microorganisms. Sensitivity to high pressure varies greatly from one bacterial species to another. A pressure of 300 MPa (3 000 bars) for 10 to 30 minutes is needed for the inactivation of Gram negative bacteria, yeasts and mildew. Bacillus subtilis spores are inactivated at 1 750 MPa (17 500 bars). A pressure of 400 MPa for 20 minutes is required to completely inactivate E. coli or bring about an 8-log reduction of Saccharomyces cerevisiae. Furthermore, 500 MPa at 25° C. for 20 minutes is required to completely inactivate Listeria innocua. The principle of this technology is applied as a batch treatment, which is suitable for small volumes but the establishment of this method on an industrial scale is difficult and costly.

Another alternative to heat is dynamic high pressure (DHP) In the milk industry, light pressure homogenization is used to reduce the diameter of fat globules in order to prevent creaming Pressure is applied to a liquid forced through an adjustable valve causing increased flow speed and a pressure loss, bringing about cavitation, chisel effect, turbulence and collision on the stationary surface, which combine to reduce the size of fat globules. The effects of DHP on bacterial cells are not yet well known. Some studies have shown changes in cell morphology as well as splits in the cytoplasmic membrane. Decreased numbers of ribosomes and the formation of spongy clear areas within the cytoplasm have also been observed. Research has shown that the cellular membrane is the site most damaged by pressure. Made of phospholipids and proteins held together by hydrogen bonds ties and hydrophobic bonds, the membrane is somewhat rigid and plays a significant role in cellular respiration and transport. Increases in permeability or rupture of the cell membrane, as may happen under pressure, cause cell death. Based on this principle, DHP technology may offer a promising alternative for the cold pasteurization of milk and perhaps other liquid foods by inactivating bacterial contaminants. A more effective inactivation may be achieved using DHP compared to HHP.

The objective of this study is to evaluate the effectiveness of a dynamic high-pressure treatment for the inactivation of three major food pathogens Listeria monocytogeneses, Salmonella enteritidis and Escherichia coli O157:H7 in raw milk.

### Material and Methods

Sample preparation: Three bacterial strains were used in this study: as Listeria monocytogenese (Canadian Food Inspection Agency #105-1) as Gram positive and Escherichia coli O157:H7 (ATCC #35150) and Salmonella enteritidis (ATCC #13047) as Gram negative representatives. Bacterial strains were maintained as glycerol stock at −80° C. When needed, strains were inoculated in tryptic soy broth (Difco) and incubated at 37° C. for 12 to 18 hours. The culture was then centrifuged at 7 000 rpm for 15 minutes, washed 2 times in phosphate buffer and then used to inoculate different samples of raw milk and phosphate buffer. The final bacterial concentration was determined by enumeration on tryptic soy agar (Difco). The efficiency of the DHP treatment was estimated by the enumeration of residual bacteria in the sample and was expressed as N/Nₒ when Nₒ is the bacterial count before the DHP treatment and N, the residual bacterial count.

### DEP Treatment of Phosphate Buffer

Dynamic high pressure was performed using an Emulsiflex-C5 homogenizer (Avestin, Ottawa). Parameters tested were pressure (100, 200 and 300 MPa) and number of passes (1, 3 and 5). We also tested the combined effect of a 10 minute heat treatment at 25, 45, 55 or 60° C. before DHP treatment at 200 MPa for one pass and the effect of initial bacterial concentration on the DHP treatment (200 MPa/1 pass). 50 ml of phosphate buffer (pH 7.3) was inoculated at a concentration of 10⁸-10⁹ CFU/ml. The sample was then treated at dynamic high pressure under different conditions. An enumeration for each bacterial strain was made on TSA (Difco) to determine the number of CFU for each treated sample. A serial dilution was made in phosphate buffer and 20 μL was plated on TSA. The phosphate buffer samples were observed by electron microscopy for each treatment (100, 200 and 300 MPa) to visualize the effect of high pressure on bacterial cells

### DHP Treatment of Raw Milk

Fresh raw milk was obtained from Natrel (Quebec city, Can.) the day of the experiment and divided into 50-ml samples. Each sample was then inoculated with different concentrations of L. monocytogeneses or E. coli and submitted to a DHP treatment as described above. Residual bacteria were enumerated on selective medium. Oxford medium base use with Bacto Modified Oxford Antimicrobic Supplement (Difco) was used for enumerating L. monocytogeneses and MacConkey Sorbitol Agar (Difco) was used for E. coli. Results were expressed as N/Nₒ.

### Industrial Trial

A pilot-scale test was performed at Avestin Inc. in Ottawa to evaluate the efficiency of the industrial device. Dynamic high-pressure was performed using an Emulsiflex-C160 homogenizer (Avestin, Ottawa) with a flow rate of 160 L/h. For this purpose, a raw milk sample (800 ml) was inoculated with L. innocua at 10⁷ CFU/ml and submitted to a DHP treatment at a pressure of 200 MPa with 1, 3 and 5 passes. The efficiency of the treatment applied was evaluated by enumerating the residual L. innocua in modified Oxford medium and by calculating the N/No ratio. Results were compared to those obtained in the laboratory using the Emulsiflex-C5.

### Results

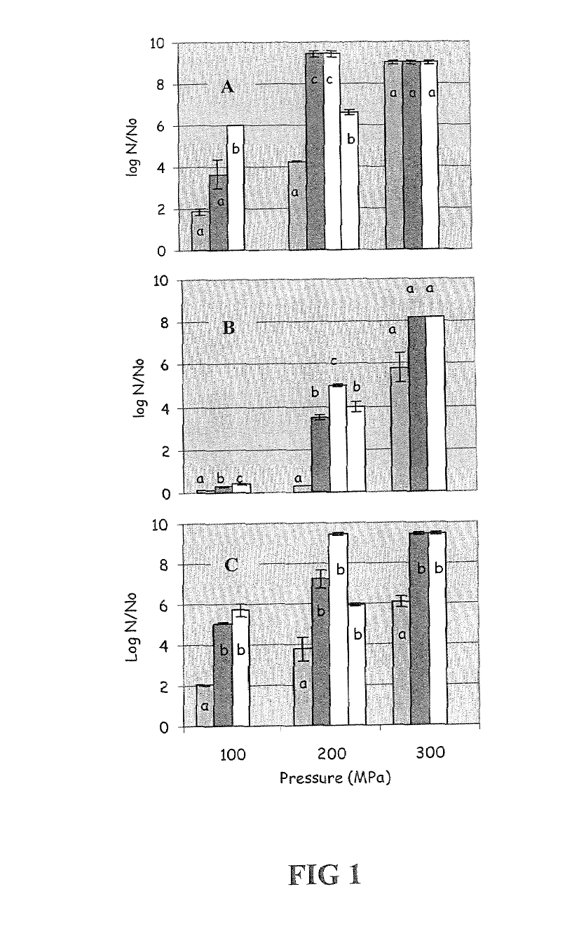

Phosphate buffer results: FIG. 1 illustrates the effect of dynamic high pressure treatment at different pressure (100, 200 and 300 MPa) on three different strains (Panel A : Salmonella enteritidis; Panel B Listeria monocytogeneses; Panel C : Escherichia coli. ▪: 1 pass; ▪: 3 passes; □: 5 passes; □: HHP). In general, Gram (+) bacteria (L. monocytogeneses) are more resistant to high pressure than Gram (−) bacteria. For L. monocytogeneses, a DHP of 300 MPa with 3 successive passes was needed to achieve a total reduction (8 log), compared. to E. coli or S. enteritidis that were completely inhibited at 200 MPa after 3 passes. The resistance of L. monocytogeneses to DHP is probably due to its wall structure, which is made up of a large number of peptidoglycan layers. This wall composition imparts to the cell a higher resistance to physical phenomena such as chisel effect, turbulence and cavitation undergone by cells in the homogenizer chamber. Gram (−) cells do not have this characteristic and are less resistant. Most of the dead bacteria show a rupture of the cell envelope due to the DHP treatment. For other bacteria, death resulted from total release of the intracellular material without the rupture of the cell envelope.

Previous research on HHP has shown that pressures between 450-500 MPa lasting 10 to 15 minutes are necessary to obtain a reduction of 7 to 8 log units for L. innocua (Gervilla, 1997). Rosella Liberti used 600 MPa of static pressure for 10 minutes to get a 5 log reduction from 10⁷ to 10² CFU/ml with L. monocytogeneses. Similar results with L. monocytogeneses were obtained after 3 passes under a pressure of 300 MPa in dynamic pressure. DHP was thus more effective than HHP.

Generally, we observe that the more pressure increases, the higher is the death rate. This fact is more evident in panel B with L. monocytogeneses. At 100 MPa, the death rate is very low to compared with 300 MPa. The pressure required to eliminate bacteria depends on temperature, pH, chemical composition of the sample and other factors. The number of passes is also a major factor affecting bacterial concentration.

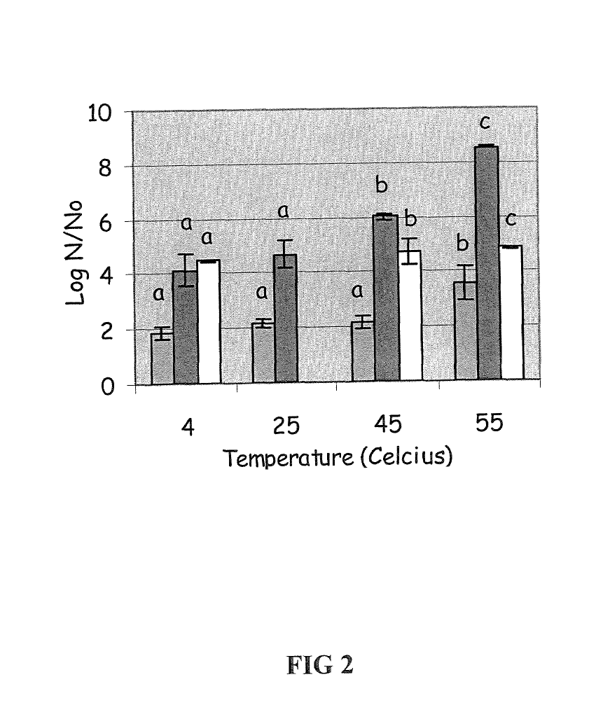

The effectiveness of DHP appears to be affected by the initial temperature of the sample (FIG. 2). An increase in sample temperature prior to DHP treatment results in a better inactivation rate especially for Salmonella and Listeria. However, no such effect was observed with E. coli. For Salmonella, heating the sample to 55° C. for 10 minutes results in an additional 4 log reduction after DHP treatment. Two and one additional log reductions were also obtained for 45° C. and 25° C. respectively. For Listeria, only 1.5 additional log reduction was obtained when the sample was heated to 55° C. for 10 minutes prior to DHP treatment compared to unheated samples. Heat likely weakens the cell membrane hydrogen and hydrophobic bonds and the bacteria consequently become less resistant to high pressure.

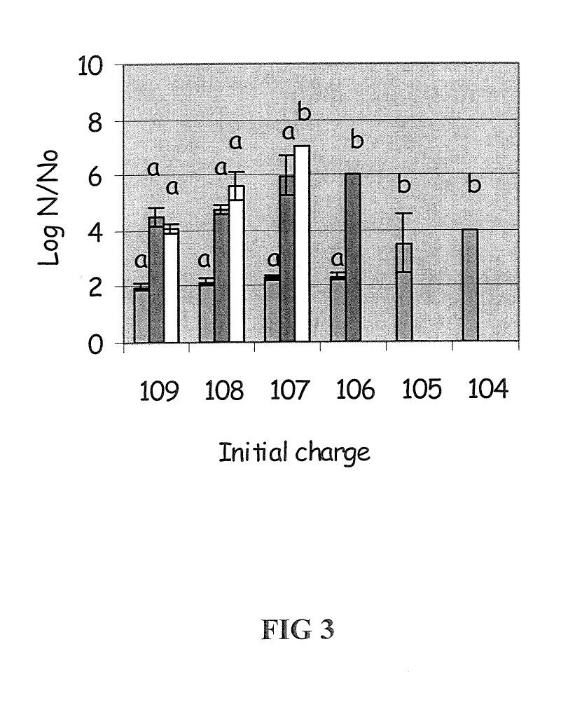

The impact of initial load on the DHP treatment (200 MPa/1 pass) is shown in FIG. 3. In general, best inactivation rates were obtained with the lowest bacterial concentration. Once again, L. monocytogenes was shown to be the more resistant bacteria compared to the other strains. For Listeria, a total inactivation effect was obtained at a concentration of 10⁴ CFU/ml while the same effect was obtained at 10⁶ and 10⁷ CFU/ml for S. enteritidis and E. coli respectively.

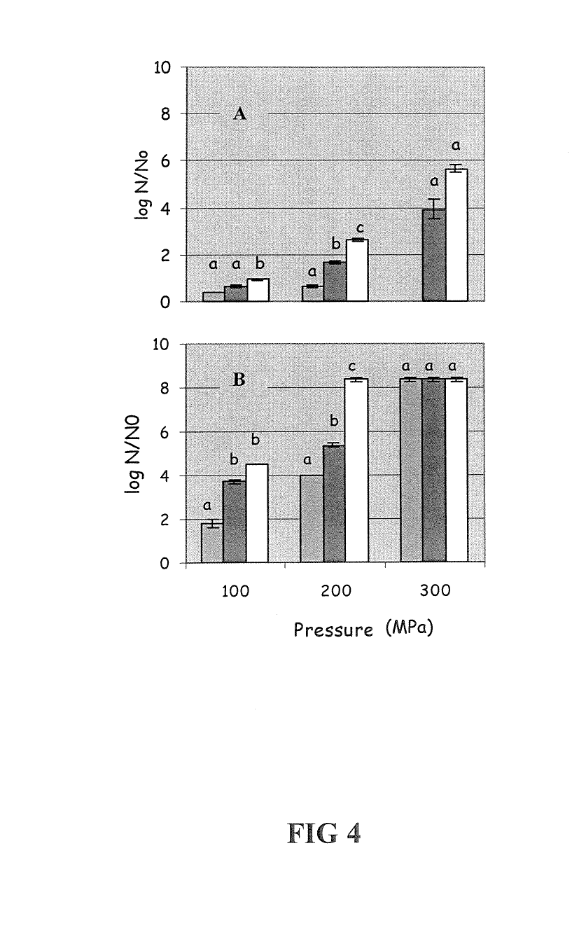

Raw milk results: Two pathogens were tested in milk samples, L. monocytogenese and E. coli. The effect of pressure and number of passes is shown in FIG. 4 (Panel A: Listeria monocytogeneses; Panel B: Escherichia coli. ▪: 1 pass; ▪: 3 passes; □: 5 passes). The reduction of viable bacteria is generally a little more then 2 log smaller than that obtained in phosphate buffer experiments. At 200 MPa (5 passes), a 5.3 log reduction was obtained in the phosphate buffer, whereas in raw milk, only 2.6 reduction was obtained for L. monocytogeneses. This phenomenon is even more evident under 300 MPa pressure with 8.3 log and 5.6 log for phosphate buffer and milk respectively.

This difference can be related to the fact that some milk elements such as proteins and fat should have a protective effect on bacteria. The bacteria were fixed to the fat globules and when the sample was homogenized, these globules reduce the effect of physical phenomena such as cavitation, chisel effect and turbulence on the bacteria. This effect was less evident at low pressures. Starting with a microbial concentration of 10⁸ CFU/ml, a drop of 1 log was observed even after 5 passes for both the buffer and milk with L. monocytogeneses.

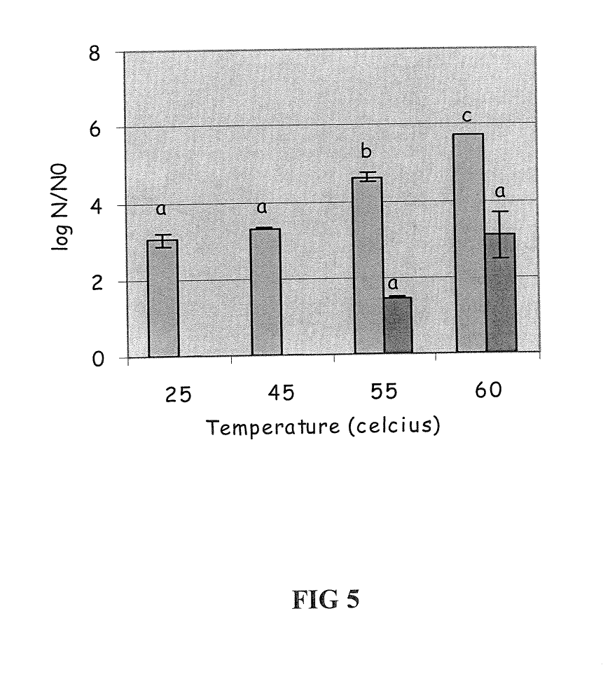

The effect of mild heat treatment before homogenization on bacterial reduction in a sample of milk is shown in FIG. 5 (▪ Escherichia coli; ▪: Listeria monocytogeneses). The tested temperatures were 25, 45, 55 and 60° C. and the pressure was maintained at 200 MPa for only one pass. We observed that the effect was minor at the lower temperatures (25 and 45° C.) but considerable at the higher temperatures (55 and 60° C.). With heating at 60° C., we obtained a difference of 1.1 log for E. coli and 1.5 log for L. monocytogenese compared to 55° C. which we attribute to the same membrane effects as in phosphate buffer.

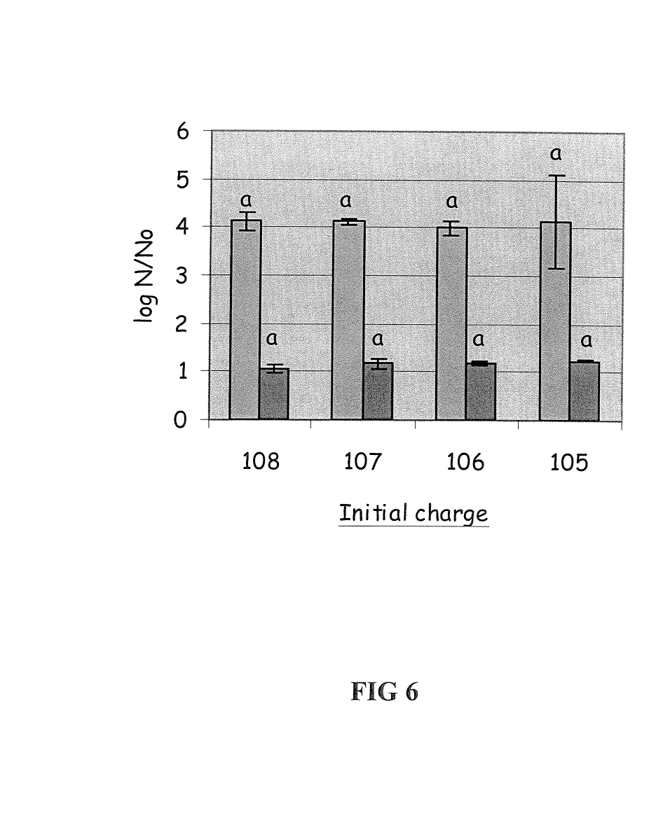

The impact of initial load on the DHP treatment (200 MPa/1 pass) milk is shown in FIG. 6. (▪ Escherichia coli; ▪: Listeria monocytogeneses). Contrary to the buffer result, we noted no effects on bacterial viability. We explain this result by the protective effect of milk. For each concentration, the effect is the same on the bacteria. This may be due to fat globules binding to the bacteria and protecting them.

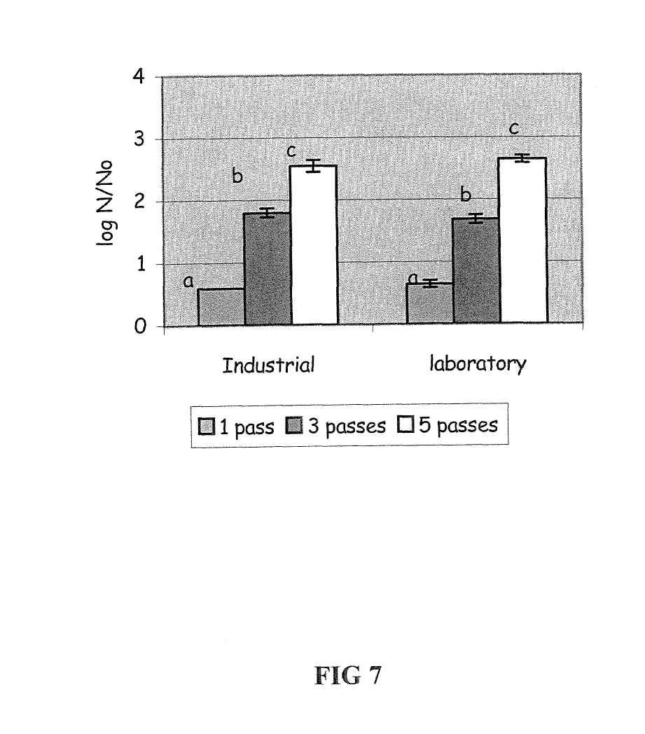

Finally, FIG. 7 shows the industrial trial compared to laboratory results for Listeria innocua under the same treatment conditions as above A similar reduction was obtained (▪: 1 pass; ▪: 3 passes; □: 5 passes).

This study has shown the effectiveness of DHP for destroying pathogenic flora in milk. It has been shown to be a viable alternative to conventional milk pasteurisation. A better bactericidal effect was obtained compared to hydrostatic pressure and milk characteristics were not affected. This new technology should be given serious consideration in the milk industry.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A process for reducing the presence of a microorganism in a liquid dairy product, said process comprising the steps of:
a) pressurizing the liquid dairy product in a continuous pressurizing circulating system comprising a dynamic high pressure (DHP) homogenizer;
b) submitting the liquid dairy product of step a) at least once and up to five times to a mechanism selected from the group consisting of sudden pressure drop, shear stress, cavitation and impingement in said dynamic high pressure (DHP) homogenizer at a temperature that does not allow the denaturation of said liquid dairy food product; and
c) collecting the liquid dairy product of step b).
whereby said dynamic high pressure (DHP) homogenizer reduces the number of viable microorganisms in said liquid dairy food product.

2. The process of claim 1, wherein said continuous pressurizing circulating system has a pressure of at least 50 MPa and up to 500 MPa.

3.-7. (canceled)

8. The process of claim 1, wherein said liquid dairy product is selected from the dairy product group consisting of milk, raw milk, flavored milk, condensed milk, ice cream milk, half-and-half, dairy cream, whipping cream, shake mix, pudding and custard.

9. The process of claim 1, wherein said liquid dairy product is raw milk contaminated with bacteria.

10. The process of claim 1, which is conducted at a temperature ranging from 4° C. to 55° C.

11. The process of claim 1, further comprising heat treating the liquid dairy product at a temperature ranging from 25° C. to 60° C. before DHP treatment.

12. The process of claim 1, wherein said liquid dairy product is submitted three or five times to the dynamic high pressure homogenizer.

13. The process of claim 1, wherein said microorganisms are selected from the group consisting of bacteria, fungi, moulds, bacteriophages, protozoa, and viruses.

14. The process of claim 13, wherein said microorganisms are bacteria.

15. The process of claim 13, wherein said microorganisms are bacteria selected from the group comprising Listeria monocytogeneses, Salmonella enteritidis, and Escherichia coli.

16. The process of claim 13, wherein said microorganisms are lactic acid bacteria bacteriophages.

17. The process of claim 13, wherein said microorganisms are viruses.

18. The process of claim 13, wherein said microorganisms are fungi or moulds.

19. The process of claim 13, wherein said microorganisms are protozoa.

20. A liquid dairy product produced by the process of claim 1 which is not pasteurized.
